(19) United States
(12) Patent Application Publication
(10) Pub. No.: US 2021/0354531 A1
(43) Pub. Date: Nov. 18, 2021

(54) SYSTEMS AND METHODS FOR SMOKER-FRIENDLY VEHICLES

(71) Applicant: MEDIDOR GROUP LLC, Manteca, CA (US)

(72) Inventor: David Ratchford, Manteca, CA (US)

(21) Appl. No.: 17/131,696

(22) Filed: Dec. 22, 2020

Related U.S. Application Data
(63) Continuation of application No. PCT/US19/38281, filed on Jun. 20, 2019.
(60) Provisional application No. 62/688,903, filed on Jun. 22, 2018.

(51) Int. Cl. B60H 1/24; B60R 11/04; B60K 35/00; B60H 3/06; B01D 46/46; B01D 46/00

(52) U.S. Cl. CPC B60H 1/248; B60R 11/04; B60K 35/00; B60R 2011/0003; B01D 46/46; B01D 46/002; B01D 46/0049; B60H 3/06

(57) ABSTRACT

Systems and methods for a safe and smoker friendly vehicle. The vehicle comprises exhaust fans and filter located at strategic locations of the vehicle. The vehicle also comprises a center divider located between a driver's compartment and a passenger's compartment of the vehicle, one or more cameras and a network communication router. The vehicle also has flame retardant interior.

### CROSS-REFERENCE TO RELATED APPLICATIONS

The present application is a continuation of International Patent Application No. PCT/US19/38281, filed Jun. 20, 2019 and claims priority to U.S. Provisional Patent Application No. 62/688,903, filed Jun. 22, 2018, the disclosures of both of which are incorporated herein by reference in their entireties.

### FIELD

The present disclosure relates to smoker-friendly vehicles, and more particularly to systems and methods for providing a comfortable in-vehicle environment for smokers.

### BACKGROUND

Smoking, including for recreational or medical purposes, has been on the rise recently. At the same time, use of private driver for hire, such as private limousine service, Lyft™, and Uber™ has increased exponentially. Currently, smoking in these vehicles are not allowed.

Therefore, there exists a need for providing a comfortable in-vehicle environment for smokers, especially for the passengers, without the above mentioned and other disadvantages.

### SUMMARY

Provided herein are example embodiments of systems, devices and methods to provide a comfortable in-vehicle environment for smokers, especially for the passengers.

Generally, the present disclosure provides a vehicle equipped with one or more exhaust fans advantageously and strategically placed, for example, throughout the passenger compartment of the vehicle. The exhaust fans (or fans for short) may pull the smoke out of the passenger compartment and recirculate fresh air into the passenger compartment. In some embodiments, the vehicle may also have filters, such as high-efficiency particulate air (HEPA) filters, placed, for example, throughout the passenger compartment to filter and clean the air. In some embodiments, the vehicle may also have a divider between the driver's compartment and the passenger's compartment to eliminate any second-hand smoke getting to the driver.

In some embodiments, the divider may include a screen, for example, a monitor or TV screen. The size of the screen may vary depending on the size of the divider for a particular vehicle. The screen may be removable. The screen may be used for entertainment, and/or for advertising smokable products and public service announcements, e.g., about the dangers of smoking and buzzed driving.

Although the disclosure describes exhaust fans, filters and the like positioned in the passenger compartment of the vehicle, they may also be positioned in other areas throughout the vehicle, including the driver area.

In some embodiments, the present disclosure may include a software program (“app”). The app may also be integrated with social media software, such as, Facebook™, Instagram™ Twitter™, etc.

In some embodiments, the app may provide an interface for a customer (e.g., a passenger) to call a service for ride from point (A) to point (B). The app would gather the customer-provided information, disburse it to available drivers in a network and determine which driver will pick up the customer. Once that is determined, the customer information is sent to the driver to pick up the customer at the given pickup location. Once the passenger is on board, through the app the customer may have the ability to log on to her social media accounts and upload photos to her accounts and perform other online communications from the comforts of the car.

The app may be compatible with current and future mobile devices and operating systems, e.g., Apple IOS™, Google Android™, and so on.

In some embodiments, the vehicle may also include flame retardant or flame-resistant interior to provide an added level of safety and security, for example, for smoking passengers.

In some embodiments, the vehicle may include a networking router for wireless access (e.g., to the Internet), and one or more cameras.

It should be noted that the present disclosure may be applicable to various types of vehicles, for example, sedans, sport utility vehicles (SUV), vans, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated in and constitute a part of the specification, are for illustrative purposes only of selected embodiments, serve to explain the principles of the invention. These drawings do not describe all possible implementations and are not intended to limit the scope of the present disclosure.

FIG. 1 illustrates an exemplary left side view of a vehicle, according to some embodiments.

FIG. 2 illustrates an exemplary left side view of a vehicle, according to some embodiments.

FIG. 3 illustrates an exemplary top view of a vehicle, according to some embodiments.

FIG. 4 illustrates an exemplary back side view of a vehicle, according to some embodiments.

FIG. 5 illustrates an exemplary top view of another vehicle, according to some embodiments.

FIG. 6 illustrates an exemplary left side view of another vehicle, according to some embodiments.

FIG. 7 illustrates an exemplary right side view of another vehicle, according to some embodiments.

### DETAILED DESCRIPTION

The present disclosure relates to systems, devices and methods to provide a comfortable in-vehicle environment for smokers.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein

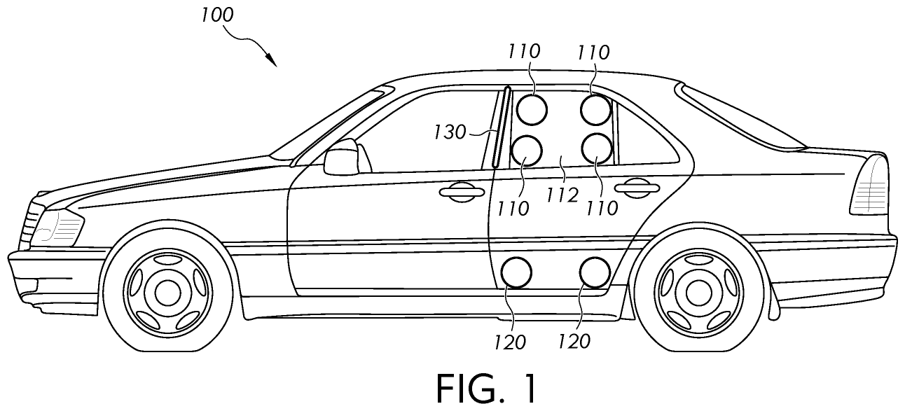

FIG. 1 illustrates an exemplary left side view of a vehicle 100, according to some embodiments of the disclosure. The vehicle 100 in FIG. 1 example is a sedan car, but the following descriptions may also apply to other types of vehicle. In some embodiments, the present disclosure may provide at least 8-10 exhaust fans in a vehicle with 2 rows of seats (front row and rear row). Four to eight fans 110 may be located on the 2 rear passenger windows 112, for example, 2 to 4 fans 110 on each window 112. In one example, the fans may be located near the corners of the window. The car may also include 2 to 4 exhaust fans 120 located on the bottom area of the passenger seats (fans 120 shown on side of car for easy reference only). The bottom area of a seat may be on the interior side of the car (the body or the door) next to the bottom of the seat (in proximity to the floor of the car) or may be under the seat cushion. Two or more exhaust fans (not shown) may be located on the bottom area of the divider 130 between the driver's compartment and the passenger's compartment. The fans may be industrial quality and custom made to fit each type and brand of vehicle.

It should be noted that the locations and numbers of exhaust fans above are only example, other locations and numbers of exhaust fans may be contemplated.

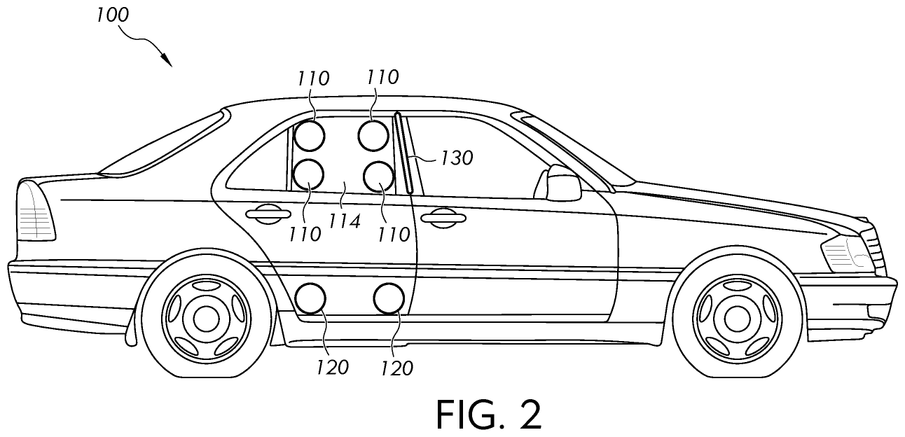

FIG. 2 illustrates an exemplary right side view of the vehicle 100 of FIG. 1, according to some embodiments of the disclosure. Four to eight fans 110 may be located on the 2 rear passenger windows 114, for example, 2 to 4 fans 110 on each window 114. The car may also include 2 to 4 exhaust fans 120 located on the bottom area of the passenger seats (fans 120 shown on side of car for easy reference only).

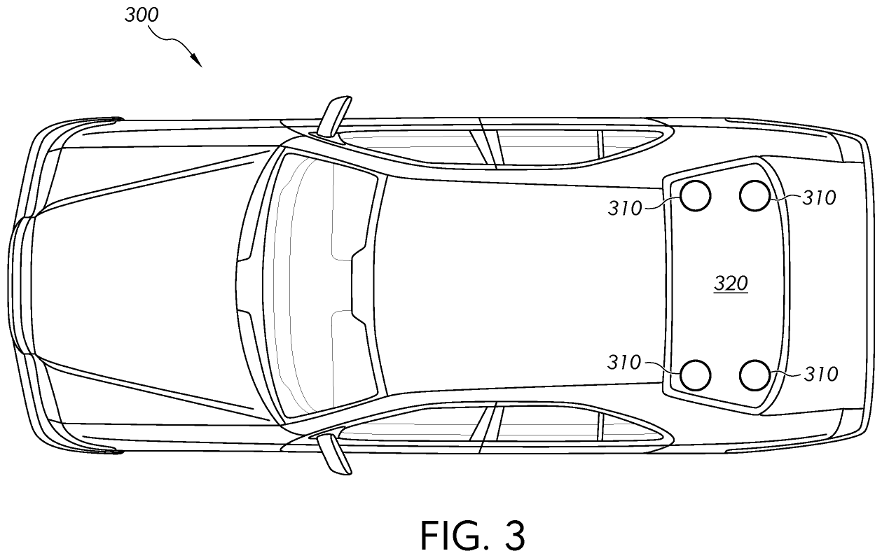

FIG. 3 illustrates an exemplary top view of a vehicle 300, according to some embodiments of the disclosure. The vehicle 300 in FIG. 3 example may be a sedan car. In some embodiments, the present disclosure may provide 4 filters 310 located on the rear window 320 of the vehicle. In one example, 2 HEPA filters may be located near the top of the rear window 320, and 2 HEPA filters may be located near the bottom of the rear window 320.

It should be noted that the type, locations and numbers of filters above are only example, other type, locations and numbers of filters may be contemplated.

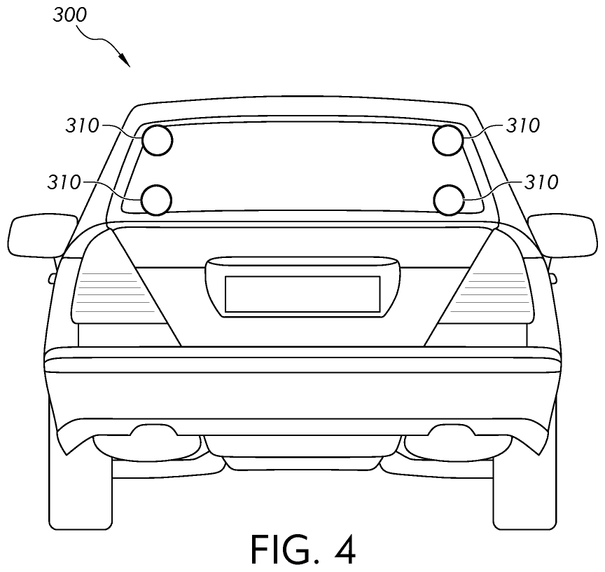

FIG. 4 illustrates an exemplary back side view of the vehicle 300 of FIG. 3, according to some embodiments of the disclosure.

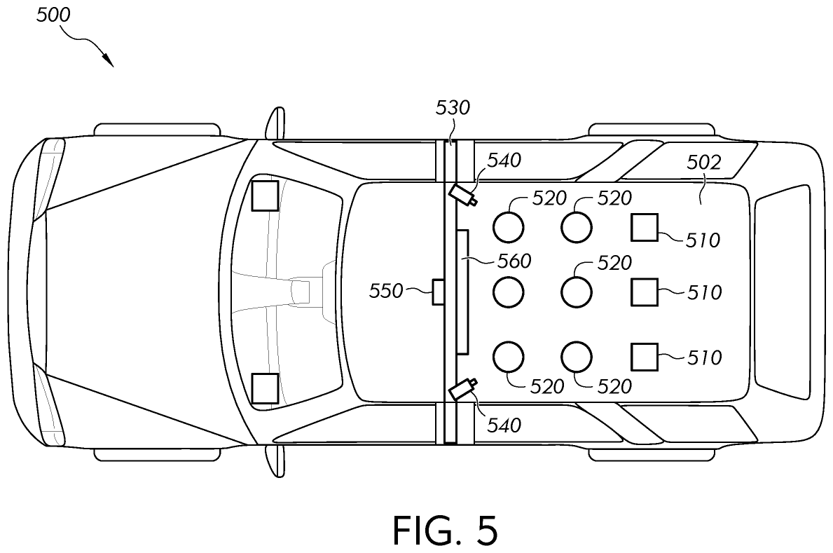

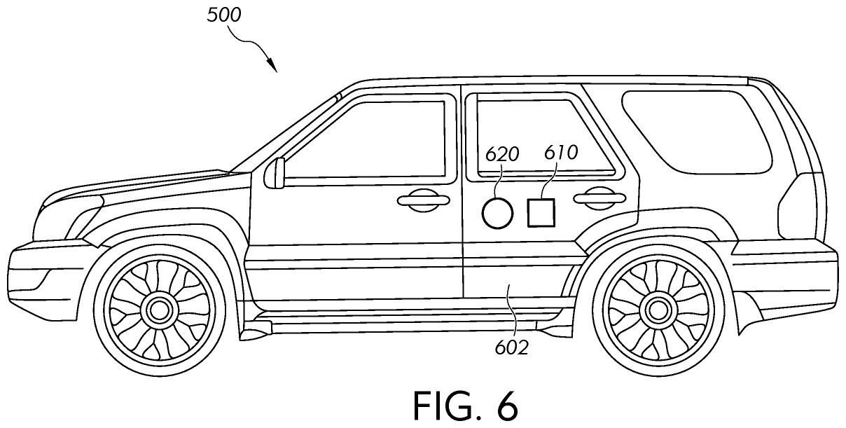

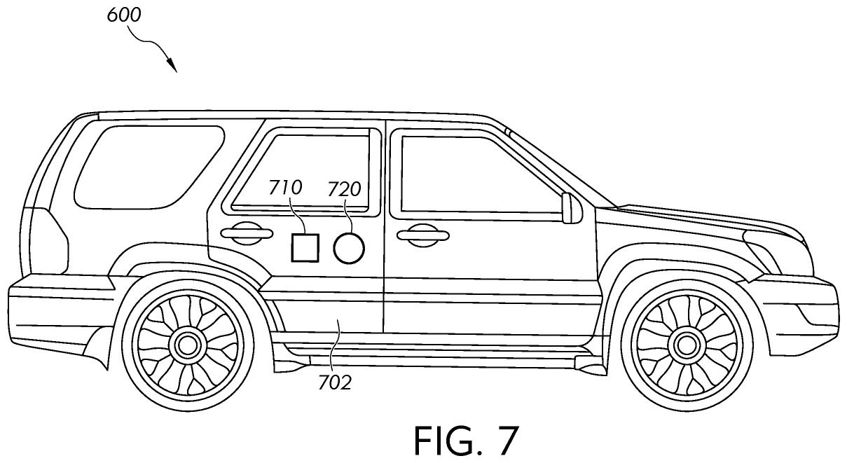

FIG. 5 illustrates an exemplary top view of a vehicle 500, according to some embodiments of the present disclosure. The vehicle 500 in FIG. 5 example may be an SUV. In some embodiments, the present disclosure may provide at least 8 exhaust fans 520. Six fans 520 may be located on the interior roof of the vehicle behind a center divider 530 in the passenger compartment, and at least 1 fan on interior of each passenger door (not shown; see FIG. 6 and FIG. 7). The SUV 500 may also include at least 5 filters. For example, 3 HEPA filters 510 may be located on the interior roof behind the center divider 530, and 1 filter on interior of each passenger door (not shown; see FIG. 6 and FIG. 7). The fans may be industrial quality and custom made to fit each type and brand of SUV.

In some embodiments, the SUV may include a center divider 530 which may include a display screen 560, at least two cameras 540 and a network communication router 550 as shown. In one example, the cameras may be located near the top of the center diver 530, and on the 2 opposite sides of the center divider 530, so as to have a wider and better view of the interior of the vehicle. In the embodiments with a display screen 560, so as to have a wider and better view of the interior of the vehicle, the cameras may be located on the 2 opposite sides of the screen.

It should be noted that the locations and numbers of exhaust fans, filters and cameras above are only example, other locations and numbers may be contemplated.

FIG. 6 illustrates an exemplary left side view of the vehicle 500 of FIG. 5, according to some embodiments of the disclosure. FIG. 6 shows the example locations of filter 610 and fan 620 located in the interior of the SUV 500 rear passenger door 602.

FIG. 7 illustrates an exemplary right side view of the vehicle 500 of FIG. 5, according to some embodiments of the disclosure. FIG. 7 shows the example locations of filter 710 and fan 720 located in the interior of the SUV 500 rear passenger door 702.

In some embodiments, the fans and filters of the present disclosure may be powered by the power system, e.g., battery, of the vehicle, similar to how other equipment is powered. In some embodiments, the fans and/or filters may be connected to a network of vents in the body of the vehicle, or to vents local to the body parts (e.g., roof, door, or floor). In some embodiments, the fans and/or filters may emit or discharge air directly through the body parts.

In some embodiments, the present disclosure may include a software program (“app”). The app may also be integrated with social media software, such as, Facebook™, Instagram™ Twitter™, etc.

In some embodiments, the app may provide an interface for a customer (e.g., a passenger) to call a service for ride from point (A) to point (B).

In some embodiments, the app may provide an interface for controlling the functions of the fans and the filters.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

These embodiments and others described herein are improvements in the fields of smoker-friendly vehicles. Other systems, devices, methods, features and advantages of the subject matter described herein will be apparent to one with skill in the art upon examination of the attached Appendices. The various configurations of these devices are described by way of the embodiments which are only examples.

It is to be understood that this disclosure is not limited to the particular embodiments described herein, as such may, of course, vary. It is also to be understood that the terminology used herein is for the purpose of describing particular embodiments only and is not intended to be limiting.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

Various aspects have been presented in terms of systems that may include several components, modules, and the like. It is to be understood and appreciated that the various systems may include additional components, modules, etc. and/or may not include all the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, circuits and applications described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), and flash memory devices (e.g., card, stick). Of course, those skilled in the art will recognize many modifications may be made to this configuration without departing from the scope of the disclosed aspects.

1. A vehicle configured to provide a safe and smoker friendly environment, comprising:
one or more exhaust fans located at one or more strategic locations of the vehicle;
one or more filters located at one or more strategic locations of the vehicle;
a center divider located between a driver's compartment and a passenger's compartment of the vehicle;
one or more cameras;
a router; and
wherein the vehicle has flame retardant interior.

2. The vehicle of claim 1, wherein at least two exhaust fans are located on each passenger window of the vehicle.

3. The vehicle of claim 1, wherein at least two exhaust fans are located on a bottom area of passenger seats of the vehicle.

4. The vehicle of claim 1, wherein at least two exhaust fans are located on a bottom area of the center divider.

5. The vehicle of claim 1, wherein at least two exhaust fans are located on an interior roof of the vehicle and behind the center divider in the passenger's compartment.

6. The vehicle of claim 1, wherein at least two filters are located on each passenger window of the vehicle.

7. The vehicle of claim 1, wherein at least two filters are located near a top on each passenger window of the vehicle, and at least two filters are located near a bottom on each passenger window of the vehicle.

8. The vehicle of claim 1, wherein at least two filters are located on a rear window of the vehicle.

9. The vehicle of claim 1, wherein at least two filters are located near a top on a rear window of the vehicle, and at least two filters are located near a bottom on the rear window of the vehicle.

10. The vehicle of claim 1, wherein at least two filters are located on an interior roof of the vehicle and behind the center divider in the passenger's compartment.

11. The vehicle of claim 1, wherein the one or more filters are high-efficiency particulate air (HEPA) filters.

12. The vehicle of claim 1, wherein the one or more cameras are located on two opposite sides of the center divider.

13. The vehicle of claim 1 further comprises a display screen located on the center divider.

14. The vehicle of claim 1, wherein the one or more exhaust fans are industrial quality and customer made to fit the vehicle.

15. The vehicle of claim 1 further comprises a software program for controlling the one or more exhaust fans.
